(19) United States
(12) Patent Application Publication
(10) Pub. No.: US 2018/0376388 A1
(43) Pub. Date: Dec. 27, 2018

(54) WIRELESS COMMUNICATING METHOD AND ASSOCIATED ELECTRONIC DEVICE

(71) Applicant: MEDIATEK INC., Hsin-Chu (TW)

(72) Inventors: Yuan-Fu Luo, Hsinchu City (TW); Kuo-Hsuan Lee, Hsinchu County (TW); Yi-Wei Chung, Hsinchu County (TW); Hai-Pin Liang, Taipei City (TW); Po-Hsun Yang, Hsinchu City (TW)

(21) Appl. No.: 16/001,955

(22) Filed: Jun. 7, 2018

Related U.S. Application Data
(60) Provisional application No. 62/523,782, filed on Jun. 23, 2017.

(51) Int. Cl. H04W 36/00; H04W 36/08; H04W 12/04

(52) U.S. Cl. CPC H04W 36/0077; H04W 36/0016; H04W 84/12; H04W 12/04; H04W 36/08

(57) ABSTRACT

A wireless communicating method includes: transmitting a querying signal to at least one access point (AP) to request at least one key cache stored in the at least one AP, wherein one of the at least one APs has established a connection with a station; and receiving said at least one key cache from the at least one AP.

### CROSS REFERENCE TO RELATED APPLICATIONS

This application claims the benefit of U.S. provisional application No. 62/523,782, filed on Jun. 23, 2017, the contents of which are incorporated herein by reference.

### BACKGROUND

The present inventions relates to a wireless communicating method, and more particularly, to a wireless communicating method applied to a fast basic service set transition.

Wireless local area network (WLAN) technology is widely used in various applications. Numerous organizations have devoted extensive resources to research improvements in WLAN data communication quality. In a WLAN, a wireless transmitting/receiving unit (WTRU) may be located within communication ranges of several access points (APs); however, the AP associated with the WTRU and the channel on which the WTRU operates may change due to the WTRU roaming among various APs. Before the WTRU can be associated with another AP for transmitting or receiving packets continuously, a handoff procedure has to be performed.

In order to ensure service quality for WLAN applications, some requirements for transmission of packets are defined. For example, for voice over IP (VoIP) services, acceptable network transmission environments with good packet data processing performance ensure that the packet delay is less than 150 ms. Users may experience echoes and tremolos caused by packet delays; longer delays will cause poor sound quality for users. According to the IEEE 802.11r standard, the time spent for a WTRU roaming from one AP to another is required to be less than 50 ms in order to maintain the quality of VOIP services in a wireless network. Therefore, finding ways to speedup the handoff procedure for a station to associate with an AP is an important issue in the market.

### SUMMARY

One of the objectives of the present invention is to provide a wireless communicating method and an associated electronic device to solve the aforementioned problem.

According to an embodiment of the present invention, a wireless communicating method is disclosed. The method comprises: transmitting a querying signal to at least one access point (AP) for requesting at least one key cache stored in the AP, wherein one of the APs has established a connection with a station; and receiving said key cache from the AP.

According to an embodiment of the present invention, an electronic device is disclosed. The electronic device comprises: a storage device and a processor, wherein the storage is arranged to store a program code, and the processor is arranged to execute the program code. When loaded and executed by the processor, the program code instructs the processor to execute the following steps: transmitting a querying signal to at least one access point (AP) for requesting at least one key cache stored in the AP, wherein one of the APs has established a connection with a station; and receiving said key cache from the AP.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communicating system including an access point executing the wireless communicating method according to an embodiment of the present invention.

FIG. 2 is a diagram illustrating the wireless communicating system including the access point executing the wireless communicating method according to a first embodiment of the present invention following the embodiment of FIG. 1.

FIG. 3 is a diagram illustrating the wireless communicating system including the access point executing the wireless communicating method according to a second embodiment of the present invention following the embodiment of FIG. 1.

FIG. 4 is a diagram illustrating the wireless communicating system including the access point executing the wireless communicating method according to a third embodiment of the present invention following the embodiment of FIG. 1.

FIG. 5A is a flowchart illustrating the wireless communicating method according to an embodiment of the present invention.

FIG. 5B is a flowchart illustrating the wireless communicating method according to an embodiment of the present invention following the flowchart of FIG. 5A.

FIG. 6 is a diagram illustrating an electronic device according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

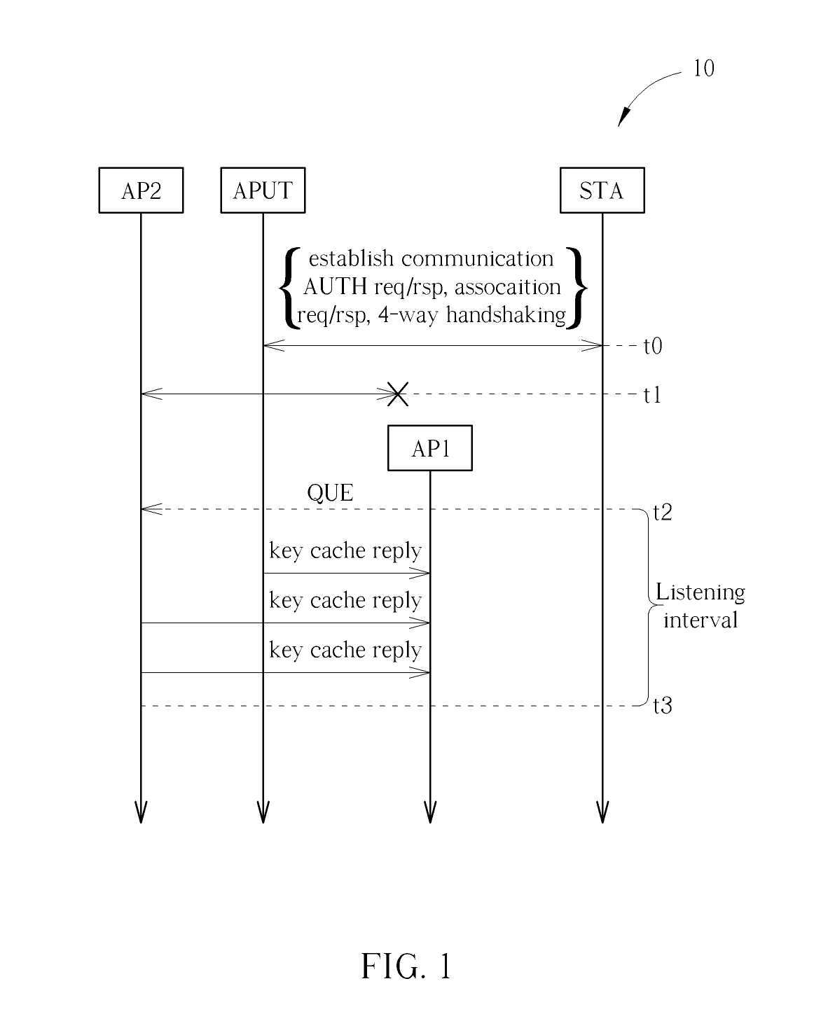

FIG. 1 is a diagram illustrating a wireless communicating system 10 according to an embodiment of the present invention. The wireless communicating system 10 comprises access points AP1, AP2 and APUT, and a station STA trying to establish a communication with one of the access points. It should be noted that the wireless communicating system 10 may comprise more access points in other embodiments. In FIG. 1, the vertical axis represents time. In this embodiment, the access point AP1 has not started up until the time point t2, and the access point APUT first establishes communication with the station STA at the time point to. Conventionally, the steps of establishing the communication between the access point APUT and the station STA comprise an authentication (AUTH) request/response, association request/response and 4-way handshaking, wherein in 4-way handshaking, the access point APUT is capable of calculating a specific key cache dedicated to communicating with the station STA. As defined in the Institute of Electrical and Electronics Engineers (IEEE) 801.11r standard, the key cache is a 256 bits key, also known as Pairwise Master Key R1 (PMK-R1), and the access point APUT currently communicating with the station STA is defined as a key holder. After establishing the communication with the station STA, the access point APUT transfers the specific key cache to adjacent access points which are in the same mobile domain (in this case, the access points AP1 and AP2 at the time point t1), so the station STA can perform fast roaming from the access point APUT to another when it is necessary. At this moment, however, the access point AP1 has not started up yet, so the specific key cache transferred from the access point APUT will not be received successfully. When the station STA tries to establish communication with the access point AP1, the fast roaming operation will fail due to the access point AP1 missing the specific key cache, and it will cost extra time and effort to complete fast roaming. The present invention thus provides a method for the access point AP1 so the fast roaming can be successfully executed.

When the access point AP1 starts up at the time point t2, the access point AP1 transmits a querying signal QUE to the backend network. The querying signal QUE is a multicast key query signal which will be transmitted to all the access points in the network: in this case, the access points APUT and AP2, to request for all the key caches stored in the access points APUT and AP2. All the access points receive the querying signal QUE: in this case, the access points APUT and AP2 transmit the key caches stored therein to the access point AP1. The access point AP1 stops receiving the key caches from the access points APUT and AP2 when a reception suspending condition is fulfilled. In one embodiment, the reception suspending condition is fulfilled when the remaining capacity of a storage device such as a cache arranged to store the received key cache in the access point AP1 is not able to store a key cache anymore. In one embodiment, the reception suspending condition is fulfilled when a time interval defined as a listening interval in FIG. 1 elapses; for example, the listening interval for the access point AP1 is defined from the time point t2 to the time point t3. By requesting the key cache, the successful rate of the fast roaming operation for the access point AP1 and the station STA can be greatly improved.

For various reasons such as the listening interval elapses before the specific key cache dedicated to communicate with the station STA is received by the access point AP1; the cache arranged to store the received key caches in the access point AP1 is full before the specific key cache is received; or the access point AP1 misses the specific key cache, etc. the received key caches transferred from the access point APUT and AP2 may or may not comprise the specific key cache. The following paragraphs will discuss the different scenarios.

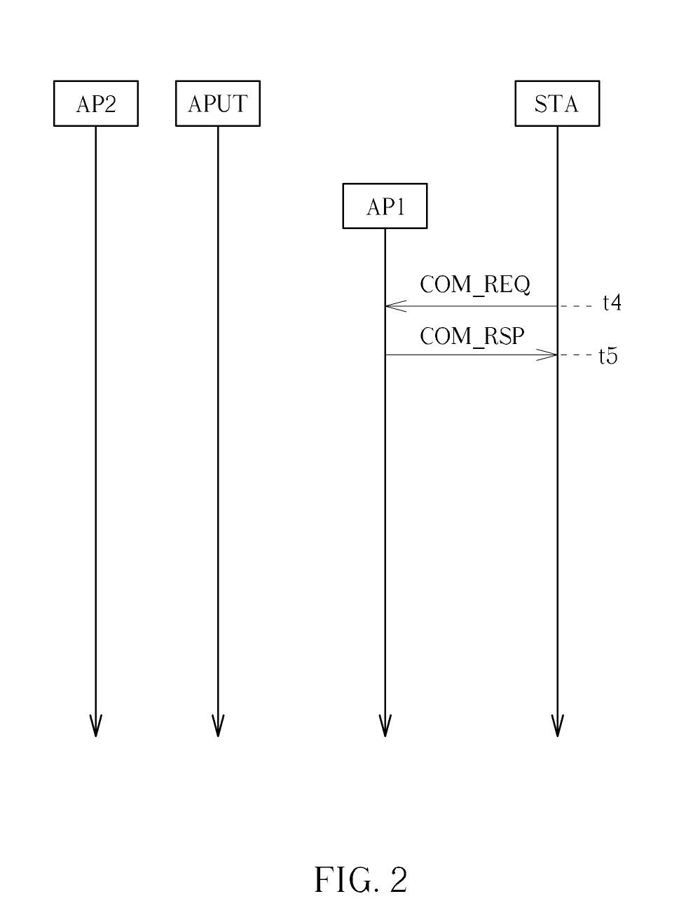

Assume the specific key cache is successfully received by the access point AP1 in the listening interval. Referring to FIG. 2, the station STA sends a communication requesting signal COM_REQ, e.g. an AUTH request to the access point AP1 for establishing the communication at the time point t4, and the access point AP1 can send a communication responding signal COM_RSP, e.g. an AUTH respond at the time point t5 by the existence of the specific key cache. The fast roaming can therefore be executed successfully.

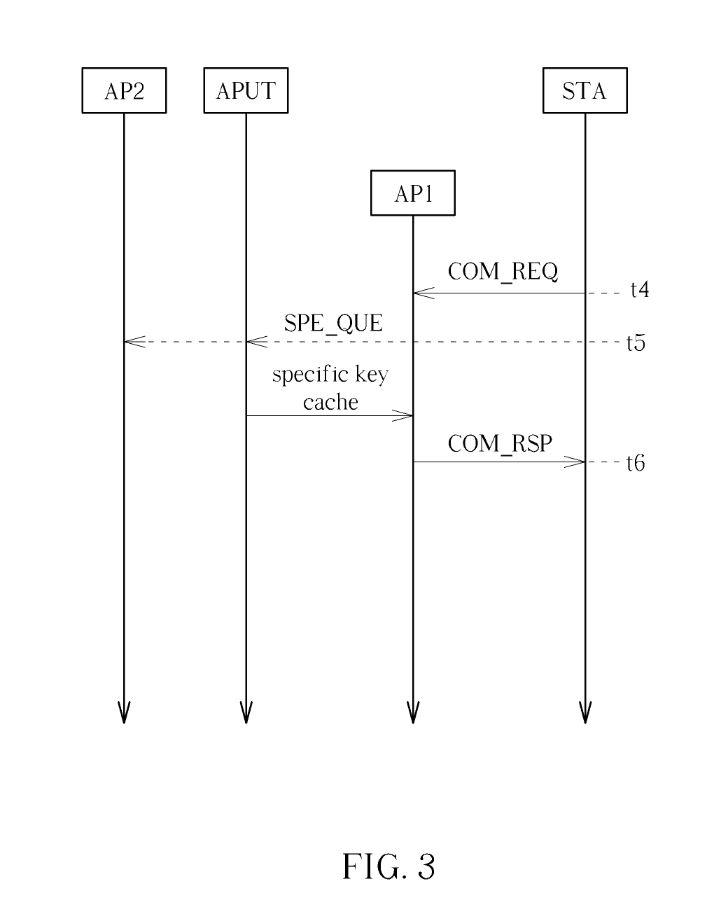

Assume the specific key cache is not received by the access point AP1 in the listen interval. Referring to FIG. 3, the station STA sends the communication requesting signal COM_REQ, e.g. an AUTH request to the access point AP1 for establishing the communication at the time point t4. At this moment, the access point AP1 is not able to transmit the communication responding signal COM_RSP to establish the communication with the station STA due to the lack of the specific key cache. The access point AP1 thus transmits a specific querying signal SPE_QUE at the time point t5 with the Media Access Control (MAC) address of the station STA to the backend network. The specific querying signal SPE_QUE is also a multicast key query signal which will be transmitted to all the access points in the network; in this case, the access points APUT and AP2, to specifically request for the specific key cache. After that, those access points in the backend network holding the specific key cache reply to the query by transmitting the specific key cache back to the access point AP1. After the specific key cache is received, the access point AP1 transmits the communication responding signal COM_RSP to the station STA at the time point t6 to establish the communication. The fast roaming can therefore be executed successfully.

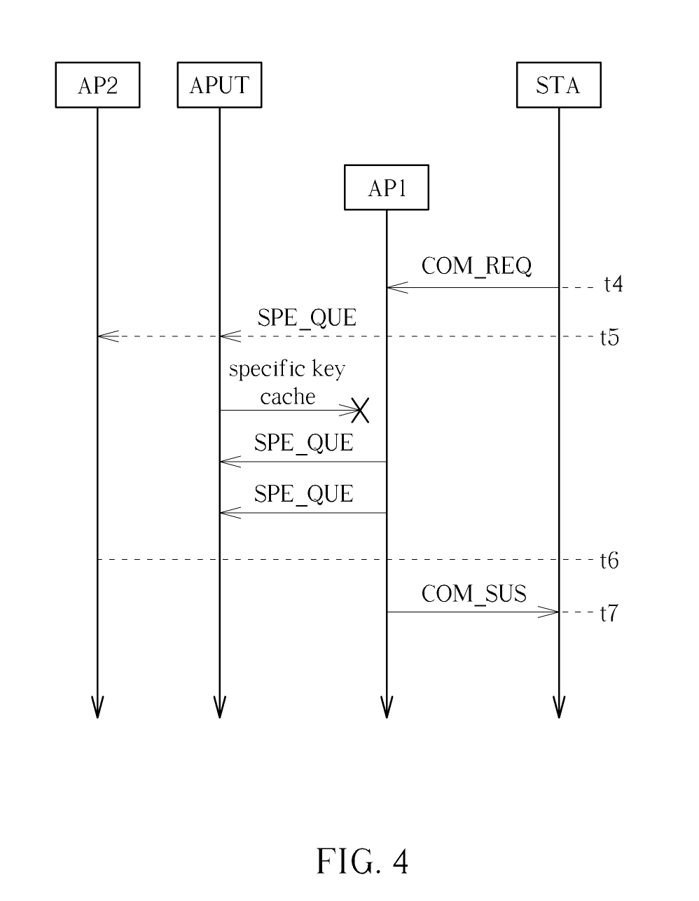

Assume the specific key cache is not received by the access point AP1 even after the specific querying signal SPE_QUE is transmitted. Referring to FIG. 4, the station STA sends the communication requesting signal COM_REQ, e.g. an AUTH request to the access point AP1 for establishing the communication at the time point t4. At this moment, the access point AP1 is not able to transmit the communication responding signal COM_RSP for establishing communication with the station STA due to the lack of the specific key cache. The access point AP1 thus transmits the specific querying signal SPE_QUE at the time point t5 with the Media Access Control (MAC) address of the station STA to the backend network. The access point A1, however, fails to receive the specific key cache from the backend network for some reason. For example, the access point AP1 misses the specific key cache, or the access points APUT and AP2 fail to receive the specific querying signal SPE_QUE. A communication suspending signal COM_SUS, e.g. an AUTH response (28) indicating the access point is unreachable, is transmitted to suspend establishing communication when a communication suspending condition is fulfilled. In one embodiment, the communication suspending condition is fulfilled when a number of times of transmitting the specific querying signal SPE_QUE to the backend network reaches a predetermined value; for example, three times. In another embodiment, the communication suspending condition is fulfilled when a time interval elapses after the specific querying signal SPE_QUE is transmitted to the backend network; for example, from the time point t5 to the time point t6.

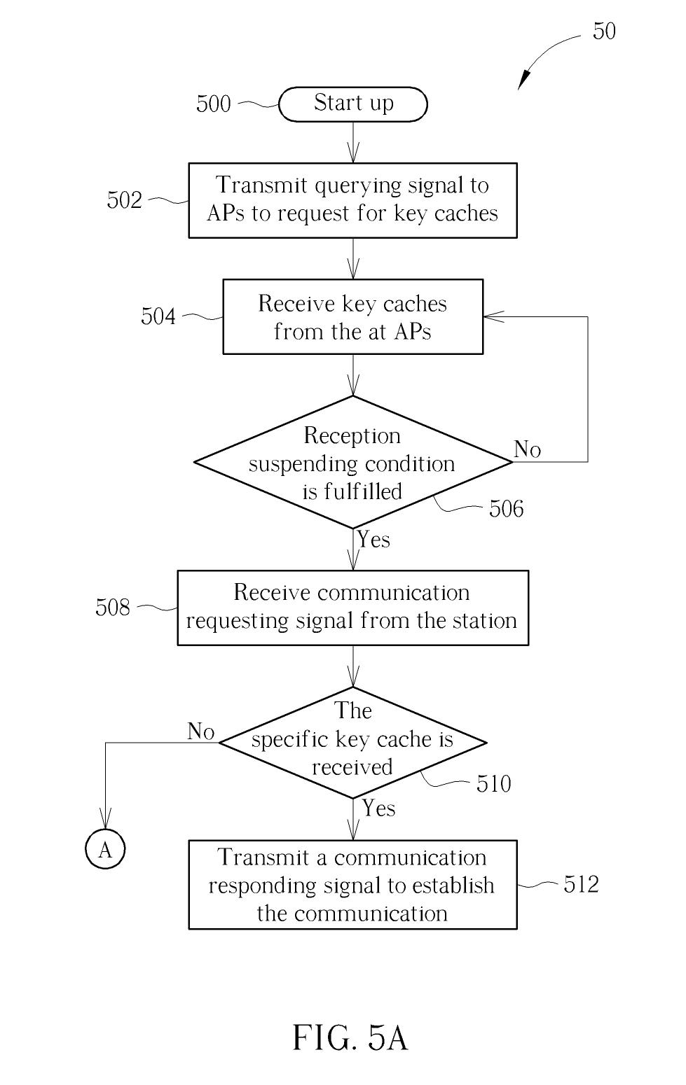

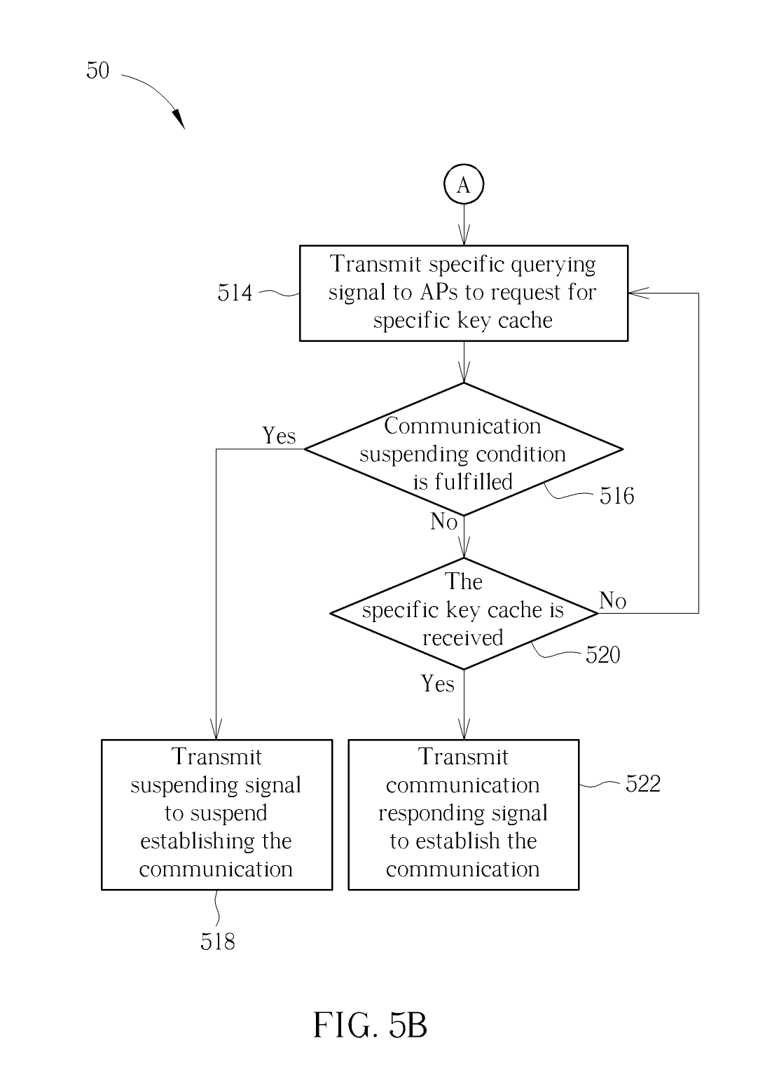

FIGS. 5A and 5B are flowcharts illustrating the wireless communicating method 50 executed by the access point AP1 according to an embodiment of the present invention. Provided that the result is substantially the same, the steps are not required to be executed in the exact order shown in FIGS. 5A and 5B. The wireless communicating method is summarized as follows.

Step 500: Start up;

Step 502: Transmit the querying signal QUE to the access points APUT and AP2 to request the key cache(s) stored therein;

Step 504: Receive the key caches from the access points APUT and AP2;

Step 506: Determine if the reception suspending condition is fulfilled: if yes, go to step 508; otherwise, go to step 504;

Step 508: Receive the communication requesting signal COM_REQ from the station STA;

Step 510: Determine if the specific key cache is received: if yes, go to step 512; otherwise, go to step 514;

Step 512: Transmit the communication responding signal COM_RSP to establish the communication;

Step 514: Transmit the specific querying signal to the access points APUT and AP2 to specifically request the specific key cache;

Step 516: Determine if the communication suspending condition is fulfilled: if yes, go to step 518; otherwise, go to step 520;

Step 518: Transmit the communication suspending signal COM_SUS to suspend establishing the communication;

Step 520: Determine if the specific key cache is received: if yes, go to step 522; otherwise, go to step 514; and

Step 522: Transmit the communication responding signal COM_RSP to establish the communication.

Those skilled in the art should readily understand the implementation details of the flowchart shown in FIGS. 5A and 5B after reading the paragraphs above. The detailed description is omitted here for brevity.

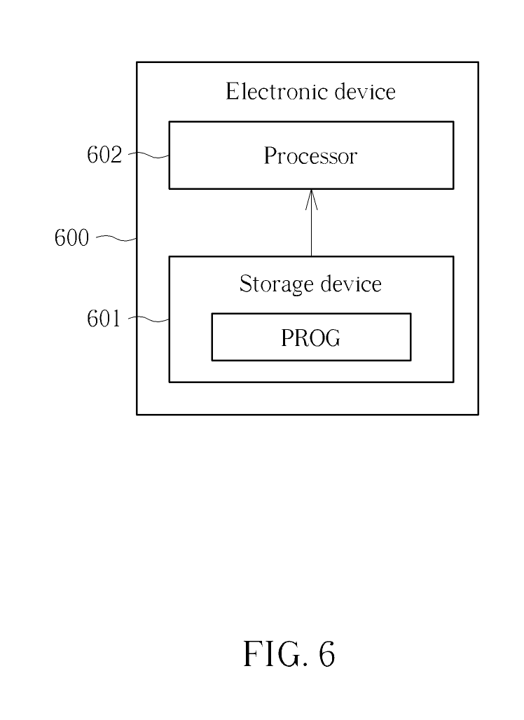

FIG. 6 is a diagram illustrating an electronic device 600 according to an embodiment of the present invention. The electronic device 600 can be used to implement the access point AP1 shown in the embodiments of FIG. 1-4 for executing the wireless communicating method provided by the present invention. As shown in FIG. 6, the electronic device 600 comprises a storage device 601 for storing a program code PROG and a processor 602. When loaded and executed by the processor 602, the program code PROG instructs the processor 602 to execute the wireless communicating method 50 shown in the flowchart in FIGS. 5A and 5B. The detailed description is omitted here for brevity.

Briefly summarized, the present invention provides a wireless communicating method executed by an access point after starting up. The access point requests key caches stored in other access points which are in the same domain to facilitate the fast roaming. When a specific key cache dedicated to establish the communication with a station is not in the received key caches, the access point further requests it to improve the successful rate of fast roaming.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communicating method, comprising:
transmitting a querying signal to at least one access point (AP) to request at least one key cache stored in the at least one AP, wherein one of the at least one APs has established a connection with a station; and
receiving said at least one key cache from the at least one AP.

2. The wireless communicating method of claim 1, further comprising:
receiving a communication requesting signal from the station for establishing a communication with the station after receiving said at least one key cache; and
when establishing the communication with the station fails, transmitting a specific querying signal to the at least one AP to request a specific key cache that is needed to establish the communication with the station.

3. The wireless communicating method of claim 2, further comprising:
transmitting a communication responding signal to the station for communicating with the station after receiving the specific key cache from the at least one AP.

4. The wireless communicating method of claim 2, further comprising:
transmitting a communication suspending signal to the station to suspend establishing the communication with the station when a communication suspending condition is fulfilled.

5. The wireless communicating method of claim 4, wherein when a number of times of transmitting the specific querying signal to the at least one AP reaches a predetermined value before the specific key cache is received, the communication suspending condition is fulfilled.

6. The wireless communicating method of claim 4, wherein when a predetermined time interval elapses after the specific querying signal is transmitted to the at least one AP and before the specific key cache is received, the communication suspending condition is fulfilled.

7. The wireless communicating method of claim 1, further comprising:
receiving a communication requesting signal from the station for establishing a communication with the station after receiving said at least one key cache; and
transmitting a communication responding signal to the station for communicating with the station.

8. The wireless communicating method of claim 1, further comprising:
stopping receiving said at least one key cache from the at least one AP when a reception suspending condition is fulfilled.

9. The wireless communicating method of claim 8, wherein when a remaining capacity of a cache arranged to store key caches reaches a predetermined threshold, the reception suspending condition is fulfilled.

10. The wireless communicating method of claim 8, wherein when a predetermined time interval elapses after the querying signal is transmitted to the at least one AP, the reception suspending condition is fulfilled.

11. An electronic device, comprising:
a storage device, arranged to store a program code; and
a processor, arranged to execute the program code;
wherein when loaded and executed by the processor, the program code instructs the processor to execute the following steps:
transmitting a querying signal to at least one access point (AP) to request at least one key cache stored in the at least one AP, wherein one of the at least one APs has established a connection with a station; and
receiving said at least one key cache from the at least one AP.

12. The electronic device of claim 11, wherein the program code instructs the processor to further execute the following steps:
receiving a communication requesting signal from the station for establishing a communication with the station after receiving said at least one key cache; and
when establishing the communication with the station fails, transmitting a specific querying signal to the at least one AP to request a specific key cache that is needed to establish the communication with the station.

13. The electronic device of claim 12, wherein the program code instructs the processor to further execute the following step:
transmitting a communication responding signal to the station for communicating with the station after receiving the specific key cache from the at least one AP.

14. The electronic device of claim 12, wherein the program code instructs the processor to further execute the following step:
transmitting a communication suspending signal to the station to suspend establishing the communication with the station when a communication suspending condition is fulfilled.

15. The electronic device of claim 14, wherein when a number of times of transmitting the specific querying signal to the at least one AP reaches a predetermined value before the specific key cache is received, the communication suspending condition is fulfilled.

16. The electronic device of claim 14, wherein when a predetermined time interval elapses after the specific querying signal is transmitted to the at least one AP and before the specific key cache is received, the communication suspending condition is fulfilled.

17. The electronic device of claim 11, wherein the program code instructs the processor to further execute the following steps:
receiving a communication requesting signal from the station for establishing a communication with the station after receiving said at least one key cache; and
transmitting a communication responding signal to the station for communicating with the station.

18. The electronic device of claim 11, wherein the program code instructs the processor to further execute the following step:
stopping receiving said at least one key cache from the at least one AP when a reception suspending condition is fulfilled.

19. The electronic device of claim 18, wherein when a remaining capacity of a cache arranged to store key caches reaches a predetermined threshold, the reception suspending condition is fulfilled.

20. The electronic device of claim 18, wherein when a predetermined time interval elapses after the querying signal is transmitted to the at least one AP, the reception suspending condition is fulfilled.
